(19) United States
(12) Patent Application Publication
(10) Pub. No.: US 2026/0174228 A1
(43) Pub. Date: Jun. 25, 2026

(54) MULTI-COMPARTMENT CARRIER ATTACHMENT

(71) Applicant: Dubai Future Foundation, Dubai (AE)

(72) Inventors: Tanzim Ahmed, Dubai (AE); Julian Ferling, Dubai (AE); Eduardo Bitencourt, Dubai (AE); Mohammad Alhareb, Dubai (AE); Tarek Taha, Dubai (AE); Khalifa AlQama, Dubai (AE)

(73) Assignee: Dubai Future Foundation, Dubai (AE)

(21) Appl. No.: 19/426,329

(22) Filed: Dec. 19, 2025

Related U.S. Application Data
(60) Provisional application No. 63/737,074, filed on Dec. 20, 2024.

(51) Int. Cl. A47B 81/00; B25J 19/00

(52) U.S. Cl. CPC A47B 81/00; B25J 19/0025

(57) ABSTRACT

A multi-compartment attachment for storing items is disclosed. The multi-compartment attachment includes a plurality of cabinets formed on a front surface of the multi-compartment attachment for receiving the items, and a plurality of cabinet doors that are pivotally connected to the front surface. Each of the cabinet doors is operable to cover or uncover a respective cabinet.

### CROSS-REFERENCE TO RELATED APPLICATIONS

The present application claims priority to U.S. Provisional Patent Application No. 63/737,074, titled “MULTI-COMPARTMENT CARRIER ATTACHMENT” and filed on Dec. 20, 2024, the entire contents of which is hereby incorporated by reference herein for all purposes.

### TECHNICAL FIELD

The present disclosure relates to a carrier attachment and in particular to a multi-compartment carrier attachment.

### BACKGROUND

The global warehousing and logistics industry is experiencing unprecedented growth, driven by the rapid expansion of e-commerce, customer expectations for faster delivery times, and just-in-time inventory practices. As demand increases, warehouses face significant challenges in optimizing efficiency, accuracy, and cost-effectiveness.

Automation has become essential for modern warehouses to meet these demands. Autonomous mobile robots (AMRs) and collaborative mobile robots (CMRs) are increasingly being deployed for various tasks, such as inventory movement, item picking, and order fulfillment. While these robots provide speed and efficiency, they often lack advanced compartmentalization, limiting their ability to transport diverse items in a single trip.

Most robotic transport solutions currently available operate with a single compartment or open platform, which can complicate the sorting and organization of different types of items during transport. This lack of compartmentalization leads to inefficiencies, as robots may need to make multiple trips or additional sorting processes may be required at the destination. Furthermore, the absence of user-friendly controls and safety features in existing models can make the adoption of warehouse robotics challenging, especially in environments with mixed-use facilities and a high volume of workers.

Limitations in current technology include a single-compartment design, where standard robotic solutions do not allow for organized item separation, leading to inefficiencies when transporting diverse items or fulfilling multiple orders. In addition, there are limited safety and user controls. Many robots lack accessible safety features like emergency stop switches, and their control interfaces are not always user-friendly, which can limit adoption and increase training time. Moreover, there is a lack of backup access mechanisms. In the event of power failure or technical issues, existing robots may not allow manual access to their compartments, potentially delaying critical operations.

Accordingly, systems that address the abovementioned issues remain highly desirable.

A multi-compartment carrier attachment is designed to address these issues directly. By offering a modular, multi-compartment solution, the carrier attachment allows for a more flexible, organized, and safe approach to item transport within warehouses. The system enables the robot to handle multiple item types or delivery destinations in a single trip, drastically improving efficiency and reducing labor requirements. Additionally, the attachment includes a suite of user-friendly and safety-oriented features, making it ideal for collaborative environments where robots and human operators work in close proximity. The carrier attachment may be integrated with CMRs to further improve efficiency.

### SUMMARY

In accordance with one aspect of the present disclosure, a multi-compartment attachment is used for storing items. The multi-compartment attachment includes a plurality of cabinets formed on a front surface of the multi-compartment attachment for receiving the items, and a plurality of cabinet doors that are pivotally connected to the front surface. Each of the cabinets doors is operable to cover or uncover a respective cabinet.

In accordance with one aspect of the present disclosure, one of the cabinets has a dimension different from another one of the cabinets.

In accordance with one aspect of the present disclosure, the cabinets are arranged in two vertical rows.

In accordance with one aspect of the present disclosure, the multi-compartment attachment further includes a large cabinet that has a width being twice the width of each of the cabinets, and a large cabinet door that is pivotally connected to the front surface and that is operable to cover or uncover the large cabinet.

In accordance with one aspect of the present disclosure, the large cabinet is located below the two rows of the cabinets.

In accordance with one aspect of the present disclosure, the cabinet doors covering two adjacent cabinets in the two rows open in opposite directions.

In accordance with one aspect of the present disclosure, the cabinet doors covering the cabinets in the same row open in the same direction.

In accordance with one aspect of the present disclosure, the cabinet doors open simultaneously or individually.

In accordance with one aspect of the present disclosure, the multi-compartment attachment further includes a top access hatch that conceals electronics unit of the multi-compartment attachment and that is operable to expose the electronics unit.

In accordance with one aspect of the present disclosure, the multi-compartment attachment further includes an emergency stop switch that is operable to stop operation of the multi-compartment attachment.

In accordance with one aspect of the present disclosure, the multi-compartment attachment further includes a removable tablet interface that is removably attached to the multi-compartment attachment.

In accordance with one aspect of the present disclosure, the multi-compartment attachment further includes a plurality of lifting handles and bumpers that are disposed on four sides of the multi-compartment attachment.

In accordance with one aspect of the present disclosure, the multi-compartment attachment is detachably connected to a collaborative mobile robot.

In accordance with one aspect of the present disclosure, the multi-compartment attachment is detachably connected to the collaborative mobile robot through a docking unit.

In accordance with one aspect of the present disclosure, the multi-compartment attachment further includes a mechanical override that is operable to open the cabinet doors when the multi-compartment attachment is unpowered.

### BRIEF DESCRIPTION OF THE DRAWINGS

Further features and advantages of the present disclosure will become apparent from the following detailed description, taken in combination with the appended drawings, in which:

FIGS. 1-1 and 1-2 show a multi-compartment carrier attachment from two different angles;

FIGS. 2-1 to 2-5 show different cabinet doors of the multi-compartment carrier attachment being opened;

FIG. 3 shows every cabinet door of the multi-compartment carrier attachment being opened;

FIGS. 4-1 to 4-3 show a removable tablet interface that is operated by an operator;

FIG. 5 shows cabinets of the multi-compartment carrier attachment;

FIG. 6 shows a mechanical latch override system of the multi-compartment carrier attachment;

FIGS. 7-1 and 7-2 show where an electronics unit can be placed in the multi-compartment carrier attachment;

FIG. 8 shows a plurality of lifting handles and bumpers of the multi-compartment carrier attachment;

FIGS. 9-1 to 9-3 show that the multi-compartment carrier attachment is attached to a collaborative mobile robot (CMR);

FIGS. 10-1 and 10-2 show different components of the CMR; and

FIGS. 11-1 and 11-2 show that the multi-compartment carrier attachment is attached to a docking unit.

It will be noted that throughout the appended drawings, like features are identified by like reference numerals.

### DETAILED DESCRIPTION

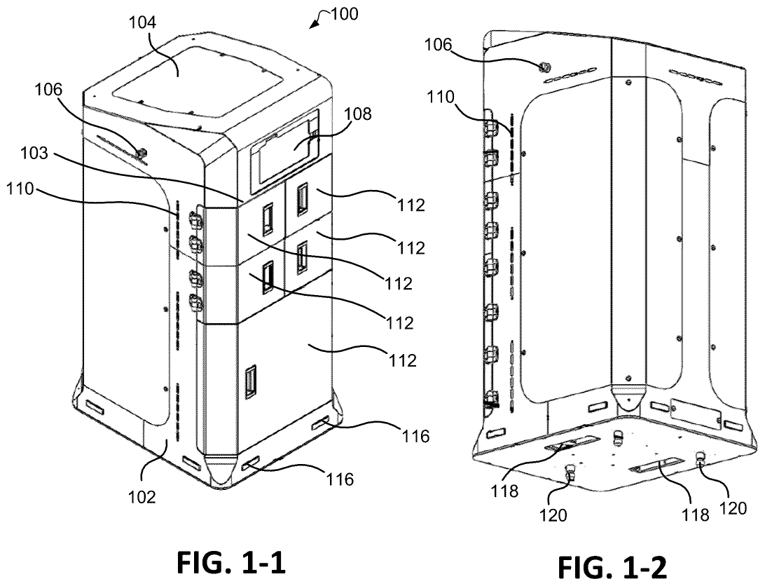

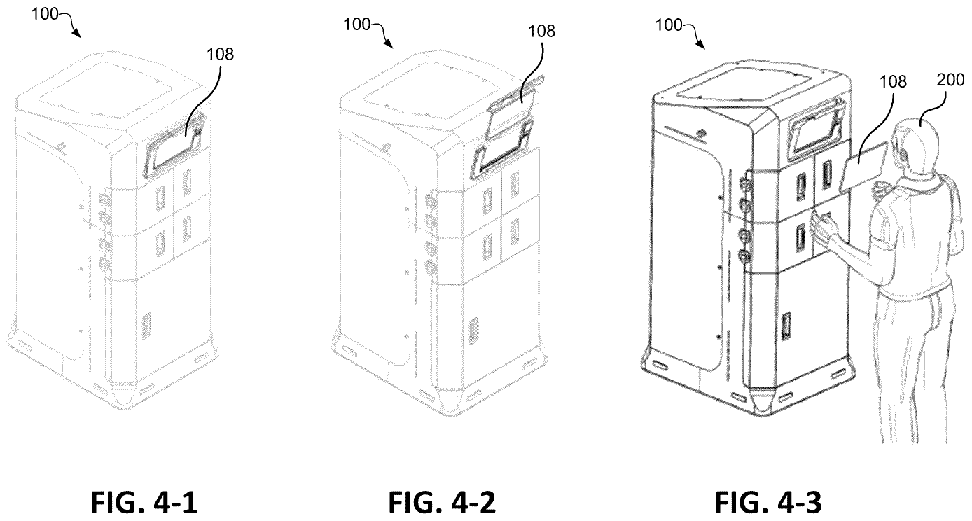

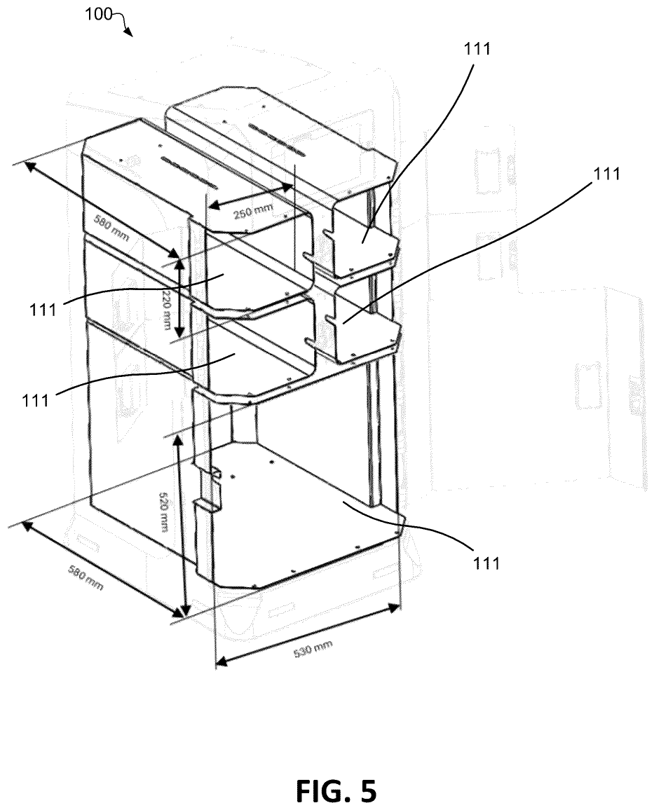

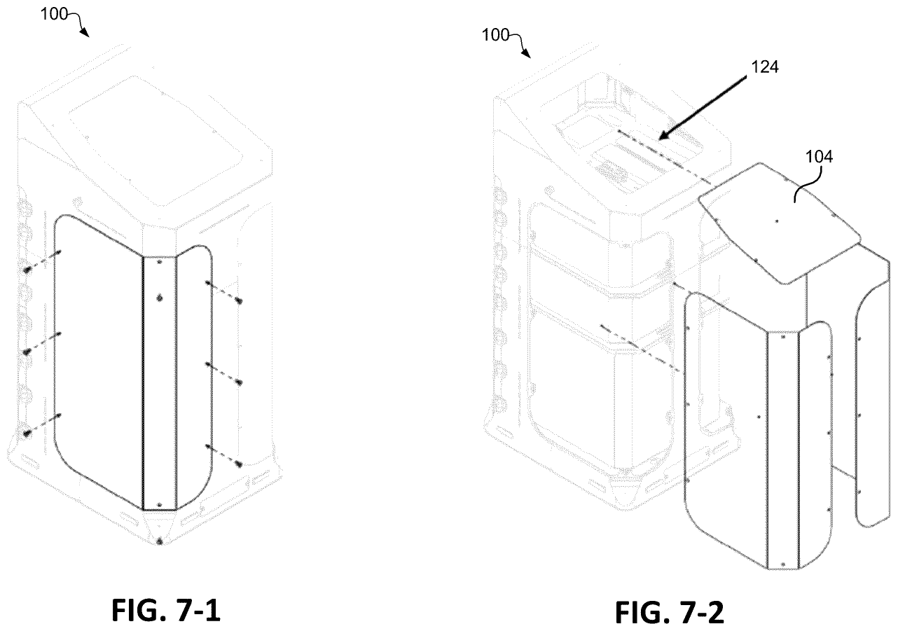

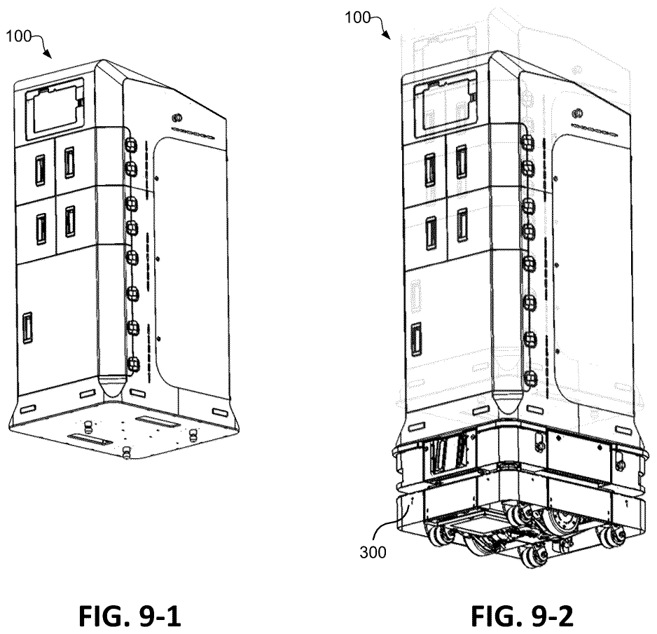

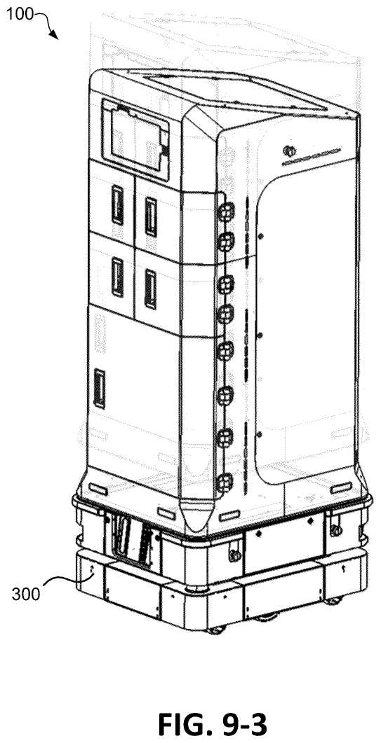

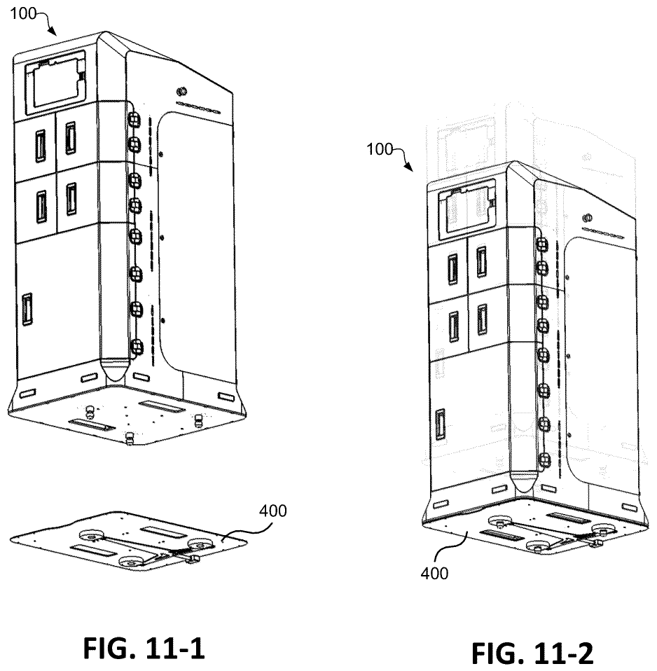

Embodiments are described below, by way of example only, with reference to FIGS. 1-1 to 11-2.

The multi-compartment carrier attachment (also referred to as “attachment” hereinafter) introduces a specialized modular attachment that can be used with, for example, a CMR, specifically designed to enhance efficiency in warehouse delivery applications. This attachment allows the CMR to transport and manage multiple categories of items in a single trip, thanks to its multi-compartment drawer system, which separates items into dedicated compartments for secure, organized, and quick transport.

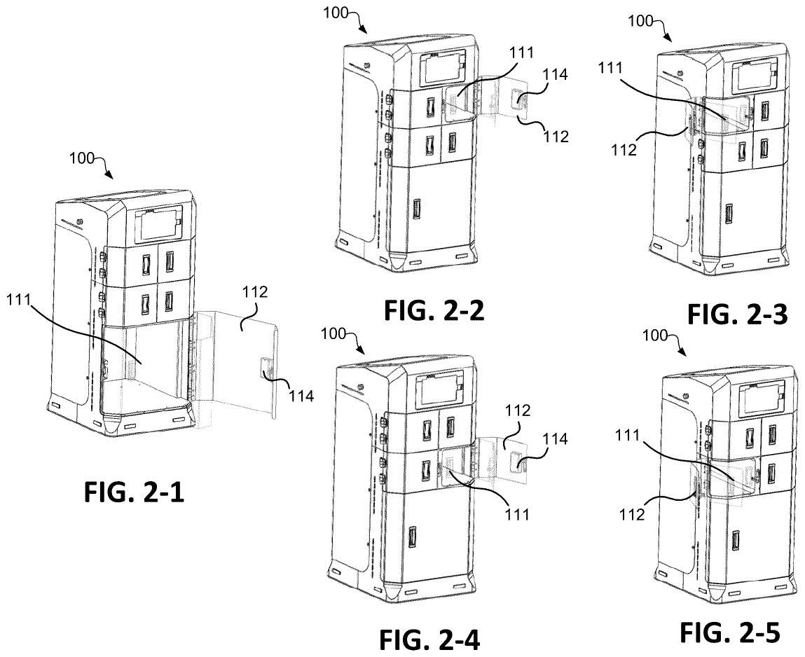

Referring to FIGS. 1-1 and 1-2, the multi-compartment carrier attachment includes a top access hatch that provides convenient access for quick item loading, reducing downtime and improving operational flow.

The multi-compartment carrier attachment further includes an emergency stop switch that enables safety by allowing immediate shutdown in case of an emergency.

The multi-compartment carrier attachment further includes a removable tablet interface that offers a user-friendly control panel, allowing operators to monitor and control the CMR with minimal training.

The multi-compartment carrier attachment further includes status lights that visually indicate the operational state and error alerts for rapid diagnostics.

The multi-compartment carrier attachment also features cabinet doors equipped with mechanical locks, ensuring items are securely stored in each compartment. The compartments are designed to prevent items from shifting during transit, providing stability and ensuring safe delivery.

The multi-compartment carrier attachment further includes lifting handles/bumpers that facilitate safe handling during installation or removal.

The multi-compartment carrier attachment further includes base attachment ports designed to establish secure electrical and communication connections to the CMR, ensuring seamless integration with the system. Additionally, retention pins attach to the docking unit, providing a secure connection to the CMR, preventing movement during transit, and ensuring safe delivery.

The multi-compartment carrier attachment is tailored to optimize the CMR's capability for handling a range of items, enhancing overall productivity in warehouse settings by reducing the need for multiple trips, minimizing manual sorting, and improving safety for operators.

FIGS. 1-1 and 1-2 provide a comprehensive view of the multi-compartment attachment, highlighting its features. Specifically, the multi-compartment attachment 100 includes a main body 102, a top access hatch 104 that is formed on a top side of the main body 102, an emergency stop switch 106 disposed on the main body, a removable tablet interface 108 removably disposed on the main body 102, a plurality of status lights 110 disposed on the main body 102, and a plurality of cabinet doors 112 pivotally connected to the main body 102 (e.g., connected to a front surface 103 of the attachment 100). The main body 102 of the multi-compartment carrier attachment 100 may also be provided with a plurality of lifting handles/bumpers 116, a plurality of base attachment ports 118, and a plurality of retention pins 120. The top access hatch 104 allows easy access to the electronics unit for quick and efficient servicing. The emergency stop 106 switch is prominently positioned, enabling immediate deactivation of the robot (including the multi-compartment carrier attachment 100 and/or the CMR) in case of emergencies, ensuring safety. The removable tablet interface 108 offers a user-friendly interface for seamless control and monitoring of the functions of the multi-compartment carrier attachment 100. The status lights 110 clearly indicate the operational state of the attachment 100, allowing staff to quickly identify its mode and address any issues. Referring further to FIGS. 2-1 to 2-5, each compartment 111 of the multi-compartment carrier attachment 100 is enclosed with a corresponding cabinet door 112 equipped with a mechanical lock 114, ensuring the items remain securely stored during transit. Lifting handles and bumpers 116 provide ease of handling and additional protection for the attachment 100. Finally, base attachment ports 118 establish a secure electrical and communication connection to the CMR, ensuring reliable operation.

Warehouses face the critical challenge of balancing efficiency with accuracy and safety. In particular, the limitations of single-compartment robots can lead to inefficiencies in item transport, requiring multiple trips to segregate items for different orders or delivery zones. Human operators often need to manually sort items at loading and unloading points, which increases labor costs and handling time, impacting overall productivity.

The multi-compartment carrier attachment of the present disclosure is designed to address these challenges by providing a multi-compartment system that allows the CMR to carry multiple item categories in one trip, each securely stored within a designated compartment. This structure reduces handling time, improves order accuracy, and enables faster order fulfillment, meeting the needs of high-demand warehouse environments.

The multi-compartment carrier attachment of the present disclosure provides a uniquely organized, safety-conscious, and user-friendly solution for modern warehouses. Its distinguishing features include its multi-compartment drawer system. This system allows for the separation of different item categories or orders, making the CMR capable of fulfilling multiple deliveries in one route. The compartments prevent items from shifting, improving order accuracy and reducing sorting time. In addition, emergency stop switch and status indicators are provided. These safety features enhance operational safety by allowing warehouse staff to quickly halt operations if necessary and providing at-a-glance information on the robot's status, aiding in quick troubleshooting. In addition, a removable tablet interface is provided. Such interface is designed to simplify control, and allow operators to interact with the robot's functions directly, reducing the need for centralized control and lowering the learning curve for new operators. Furthermore, a mechanical latch override is provided. In case of technical issues or power outages, the manual latch override ensures that operators can access items without delay. This feature is crucial for maintaining continuity in high-demand settings.

Some advantages of the multi-compartment carrier attachment includes enhanced efficiency. By allowing a single CMR to manage multiple item categories or orders, the multi-compartment carrier attachment reduces the need for repeated trips, thus improving productivity and reducing transit time within the warehouse. In addition, safety is improved. The inclusion of an emergency stop switch and clear status indicators improves safety in high-traffic areas, providing peace of mind to operators working alongside the robot. Furthermore, the multi-compartment carrier attachment adopts a user-friendly design. The detachable tablet interface offers a simple and intuitive way to control and monitor the CMR, reducing training requirements and easing adoption for warehouse staff. Moreover, the multi-compartment carrier attachment provides uninterrupted access with mechanical override. This feature ensures that operators can still access compartments in the event of power loss or system failure, maintaining operational flow and preventing downtime.

FIGS. 2-1 to 2-5 show different modes of the multi-compartment carrier attachment 100 with its cabinet doors 112 open, illustrating how accessible each compartment 111 is. With the cabinet doors 112 that open smoothly, loading and unloading become straightforward tasks, which helps save time in a fast-paced warehouse. Each compartment 111 is designed to hold items securely, so they don't shift or fall during movement. This accessibility ensures that warehouse operators can load items quickly without detaching the attachment 100 from the robot (e.g., the CMR), making it highly efficient for multi-order deliveries. The multi-compartment carrier attachment 100 helps streamline workflows, especially when numerous orders need to be fulfilled at once.

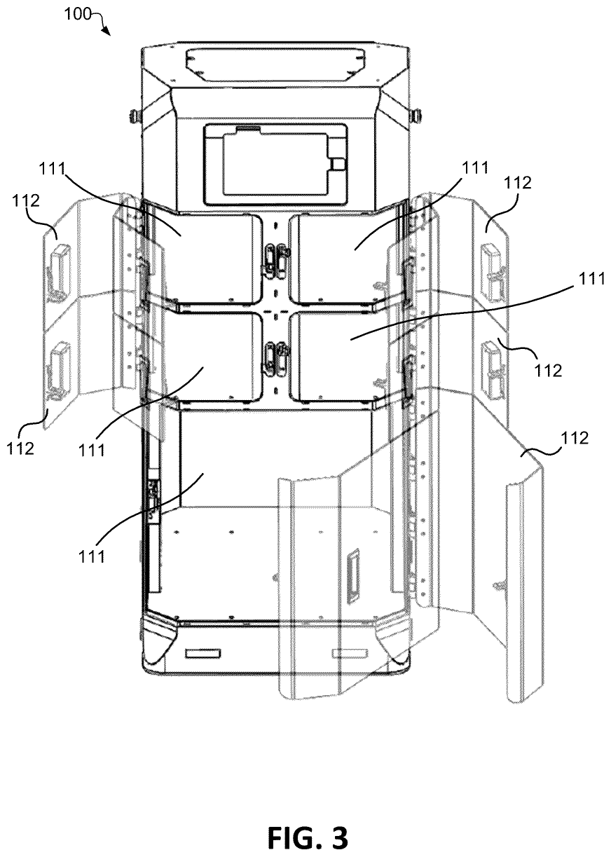

FIG. 3 shows the organized interior of the multi-compartment carrier attachment 100, showing how multiple compartments 111 are arranged in a vertical stack. Each compartment 111 is isolated with its own cabinet door 112, allowing for neat separation of different types of items, which is useful for handling multiple orders or categories in a single trip. The separate compartments 111 reduce the chance of mixing items, which minimizes sorting time at the destination. Despite its compact form, the attachment 100 maximizes storage space, ensuring that it can carry a variety of items. This organized layout makes it easier for warehouse staff to sort and retrieve items efficiently, streamlining the entire delivery process.

FIGS. 4-1 to 4-3 illustrate a warehouse operator 200 interacting with the multi-compartment carrier attachment 100, where the operator is shown opening a display holder to access the removable tablet interface 108. This interface enables intuitive monitoring and control of the attachment's functions, making it ideal for collaborative environments where robots and humans work together seamlessly.

FIG. 5 provides a detailed look at the internal layout of the compartments 111, with example measurements for depth, width, and height. It should be noted that the measurements are examples only and should not be interpreted as limiting the scope of this disclosure, and may be changed according to practical needs. Each compartment 111 is designed to efficiently utilize space while fitting a range of item sizes. The dimensions ensure that items can be stored safely without excess movement during transport. Knowing these measurements helps warehouses plan their storage and transport logistics more accurately, ensuring compatibility with standard inventory sizes. This layout optimizes the attachment's capacity while keeping it compact enough to navigate through typical warehouse pathways easily.

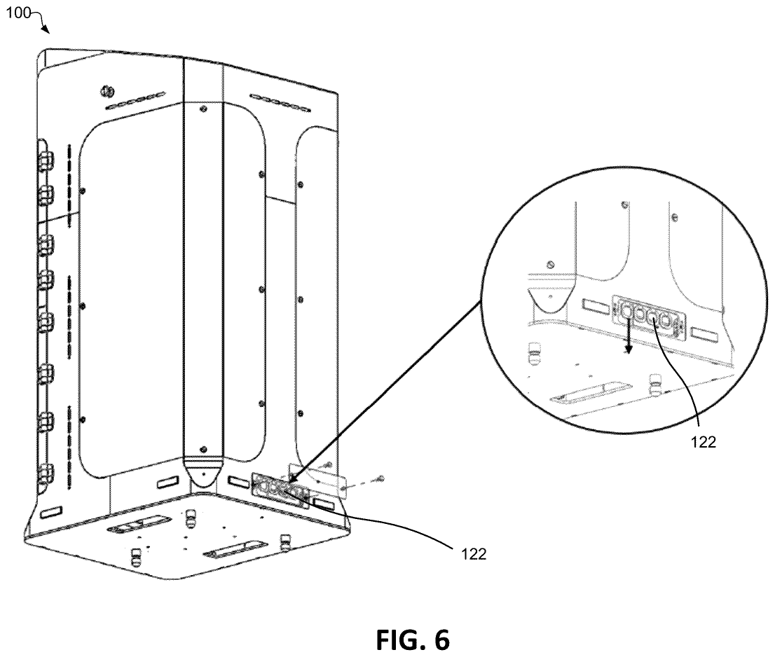

FIG. 6 shows a close-up of a mechanical latch override system 122 of the attachment 100, which contributes to maintaining access to items during power or system failures. This manual latch allows operators to open compartments even if the attachment's power is off or there's a technical glitch, ensuring that the contents are never locked away. The latch override system 122 is easy to reach and use, providing peace of mind in high-demand environments where uninterrupted access is essential. This feature ensures that operations can continue smoothly, even if technical issues arise.

FIG. 7-1 and 7-2 highlight where the electronics unit 124 is located within the attachment 100, which controls power and other functional elements. The electronics unit 124 is placed in a protected area within the attachment 100 to avoid accidental bumps or damage, but it remains accessible for quick maintenance. The top access hatch 104 serves to cover the electronics unit 124 within the attachement 100 and can be easily removed for quick access to the electronics unit 124. Having all essential electronics centralized here makes it easier to troubleshoot any issues without disassembling the entire attachment. This placement simplifies the attachment's upkeep and ensures that it operates reliably over extended use.

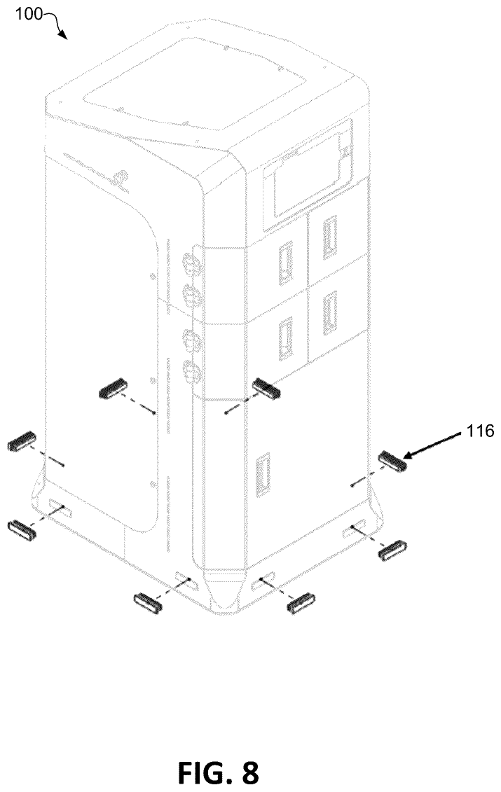

FIG. 8 shows the lifting handles and bumpers 116 integrated into the attachment 100. These lifting handles and bumpers make it easy and safe to lift or move the attachment 100 when needed, reducing the risk of strain or injury for operators. Additionally, they also act as protective buffers, safeguarding the attachment from damage if it comes into contact with other objects or equipment. These elements reflect the attachment's durability and suitability for busy warehouse environments, where rough handling is common. Together, the lifting handles and bumpers make the attachment safer and more resilient for everyday use.

FIGS. 9-1 to 9-3 are schematic views showing the multi-compartment carrier attachment 100 being connected to the CMR 300, where details of the CMR 300 are illustrated in FIGS. 10-1 and 10-2.

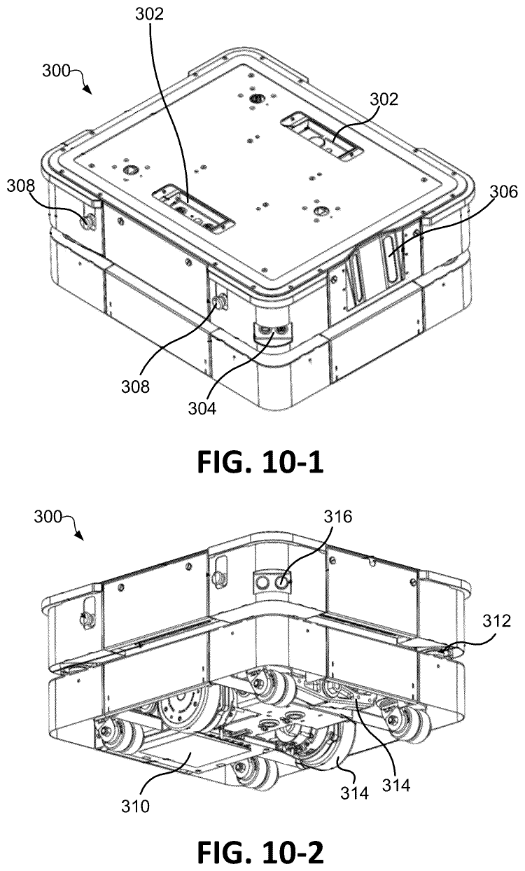

FIG. 10-1 highlights several components of the CMR 300, including external attachment ports 302 that enable integration with additional hardware or tools (e.g., the multi-compartment carrier attachment 100 of the present disclosure), service ports 304 that allow for diagnostics and communication, and 3D camera modules 306 that enhance visual awareness and navigation. Also visible are emergency stop switches 308 on each corner of the robot, providing easy access for operators to halt the robot if necessary. FIG. 10-2 showcases wireless charging unit 310, which enables the robot to recharge without manual intervention. Additionally, safety laser scanners 312 are located in the corners, offering 360-degree obstacle detection for safe navigation. Drive train units 314 and power switch 316 are clearly visible, demonstrating the robot's operational features.

FIG. 12 is a schematic view showing the multi-compartment carrier attachment 100 being connected to a docking unit 400. The docketing unit 400 may be connected between the CMR 300 (see FIGS. 10-1 and 10-2) and the multi-compartment carrier attachment 100 for facilitating connection between the two.

This multi-compartment carrier attachment can be utilized in various warehouse and fulfilment centres to enhance item transportation and delivery efficiency. It is suitable for industries such as e-commerce, retail, manufacturing, etc.

It would be appreciated by one of ordinary skill in the art that the system and components shown in the figures may include components not shown in the drawings. For simplicity and clarity of the illustration, elements in the figures are not necessarily to scale and are only schematic. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps, or components are included. The terms are not to be interpreted to exclude the presence of other features, steps, or components.

The invention may also broadly consist in the parts, elements, steps, examples and/or features referred to or indicated in the specification individually or collectively in any and all combinations of two or more said parts, elements, steps, examples, and/or features. In particular, one or more features in any of the embodiments described herein may be combined with one or more features from any other embodiment(s) described herein.

1. A multi-compartment attachment for storing items, the multi-compartment attachment comprising:
a plurality of cabinets formed on a front surface of the multi-compartment attachment for receiving the items; and
a plurality of cabinet doors that are pivotally connected to the front surface, each of the cabinet doors being operable to cover or uncover a respective cabinet.

2. The multi-compartment attachment of claim 1, wherein one of the cabinets has a dimension different from another one of the cabinets.

3. The multi-compartment attachment of claim 1, wherein the cabinets are arranged in two vertical rows.

4. The multi-compartment attachment of claim 3, further comprising:
a large cabinet that has a width being twice the width of each of the cabinets; and
a large cabinet door that is pivotally connected to the front surface and that is operable to cover or uncover the large cabinet.

5. The multi-compartment attachment of claim 4, wherein the large cabinet is located below the two rows of the cabinets.

6. The multi-compartment attachment of claim 3, wherein the cabinet doors covering two adjacent cabinets in the two rows open in opposite directions.

7. The multi-compartment attachment of claim 3, wherein the cabinet doors covering the cabinets in the same row open in the same direction.

8. The multi-compartment attachment of claim 1, wherein the cabinet doors open simultaneously or individually.

9. The multi-compartment attachment of claim 1, further comprising a top access hatch that conceals electronics unit of the multi-compartment attachment and that is operable to expose the electronics unit.

10. The multi-compartment attachment of claim 1, further comprising an emergency stop switch that is operable to stop operation of the multi-compartment attachment.

11. The multi-compartment attachment of claim 1, further comprising a removable tablet interface that is removably attached to the multi-compartment attachment.

12. The multi-compartment attachment of claim 1, further comprising a plurality of lifting handles and bumpers that are disposed on four sides of the multi-compartment attachment.

13. The multi-compartment attachment of claim 1, wherein the multi-compartment attachment is detachably connected to a collaborative mobile robot.

14. The multi-compartment attachment of claim 13, wherein the multi-compartment attachment is detachably connected to the collaborative mobile robot through a docking unit.

15. The multi-compartment attachment of claim 1, further comprising a mechanical override that is operable to open the cabinet doors when the multi-compartment attachment is unpowered.
